(19) United States
(12) Patent Application Publication
(10) Pub. No.: US 2008/0202908 A1
(43) Pub. Date: Aug. 28, 2008

(54) Remote switch actuator

(76) Inventor: Paul John Simon, Gleason, WI (US)

Correspondence Address: Paul J. Simon, W 250 CTH. CCC, Gleason, WI, 54435, US

(21) Appl. No.: 12/069,658

(22) Filed: Feb. 11, 2008

Related U.S. Application Data
(63) Continuation of application No. 60/900,706, filed on Feb. 12, 2007.

(51) Int. Cl. H01H 17/00

(52) U.S. Cl. 200/331

(57) ABSTRACT

This invention is a remote drill switch actuator assembly that will connect the switch of the cordless drill to the handle of the torque multiplying transmission device. The concept of this invention is used on a power transmission device for connecting a standard cordless battery operated drill to an ice auger. Ice augers are utilized by fisherman in the winter to drill holes in ice on frozen lakes. To the best of my knowledge there are no other patents that use a cable and lever assembly to actuate a switch on a cordless drill.

### SUMMARY OF INVENTION

Provisional patent No. 60/900,706 was granted on Feb. 12, 2007 for the Arm Saver. The Arm Saver was submitted as a complete assembly. It is a torque amplifying transmission that is used between any cordless drill driver and any hand auger. Hand augers are used to drill holes in the ice for ice fishing. During the course of the patent search, a chain drive transmission for ice augers had already been patented. We wish to patent the remote drill switch actuator assembly. Drawings for this assembly were originally submitted with the provisional patent.

### BRIEF DESCRIPTION OF ASSEMBLY DRAWINGS

FIG. 1—Is a broken assembly view, which shows both drill end and handle bar end components of the Remote Switch Actuator assembly. Detail A shows the drill end assembly in the side view. Detail B shows handle bar end assembly in the top view.

FIG. 2—Is an assembly view, which shows how the Remote Switch Actuator relates to the torque amplifying transmission, and how the transmission connects to the cordless drill/driver and auger. There are three views of the transmission to show the relation of the components. The cordless drill/driver and the auger are omitted in the top and front views for clarity.

### DETAILED DESCRIPTION

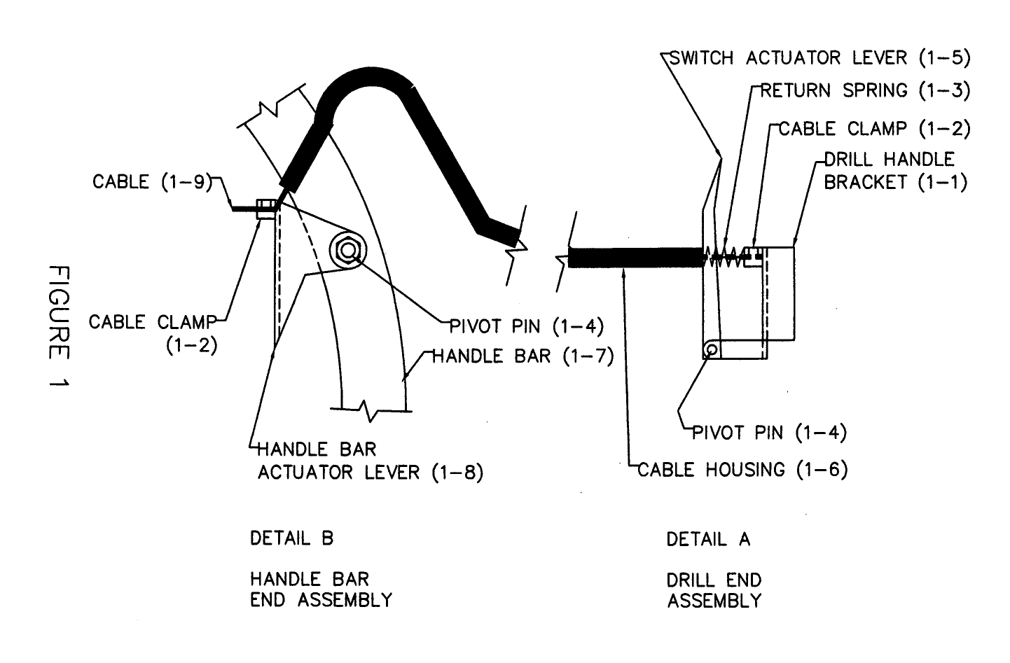

FIG. 1 is the Remote Switch Actuator. The Remote Switch Actuator assembly is a device that will connect the switch of the cordless drill to the handle of the torque multiplying transmission device. There are two levers that are connected by a cable and a spring to return the system to a neutral position. Part numbers are taken from FIG. 1. One end of the cable (1-9) is mounted to a lever (1-8) on the u-shaped handle bar (1-7) that is connected to the torque multiplying device. The other end is connected to a lever (1-5) that pivots on a bracket (1-1) is clamped to the handle of the cordless drill to depress the switch of the drill. When lever (1-8) is released, spring (1-3) returns both levers (1-5 & 1-8) to the neutral position.

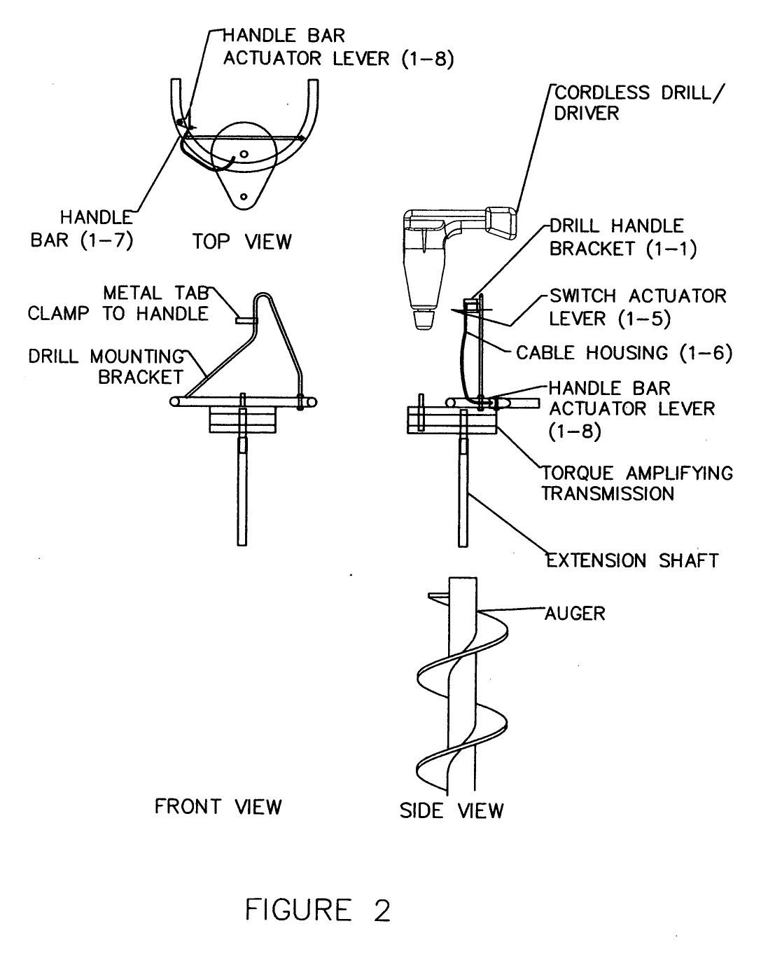

FIG. 2 is an assembly drawing showing how the transmission is positioned and gives reference to where the actuator assembly is located. The concept allows for the safe operation allowing the operator to control the unit both hands.

What is claimed is:

1. A Remote Switch Actuator assembly consisting of a lever pivoting on a handle bar clamped to a cable passing through a cable housing, a lever pivoting on a drill handle bracket, then passing through a return spring and clamped to a drill handle bracket.
